(19) United States
(12) Patent Application Publication
(10) Pub. No.: US 2007/0292066 A1
(43) Pub. Date: Dec. 20, 2007

(54) Rolling bearing for use in a cryogenic pump

(75) Inventors: Lars Kahlman, Partill (SE); Paul Dietl, Ardagger (AT); Steuart Horton, Zeist (NL)

Correspondence Address: BUCHANAN, INGERSOLL & ROONEY PC, POST OFFICE BOX 1404, ALEXANDRIA, VA, 22313-1404, US

(73) Assignee: Aktiebolaget SKF, Goteborg (SE)

(21) Appl. No.: 11/591,493

(22) Filed: Nov. 2, 2006

(30) Foreign Application Priority Data
Nov. 2, 2005 (SE) 0502447-6

(51) Int. Cl. F16C 33/62

(52) U.S. Cl. 384/492

(57) ABSTRACT

A rolling bearing for use in a cryogenic pump where the bearing is submerged in fluid of a temperature below −100 degrees centigrade, and incorporating an inside and an outside race of stainless steel, a plurality of rolling bodies positioned between the inside and outside races, and a polymeric cage spacing apart the rolling bodies between the races, wherein the inside and outside races consist of a super-tough martensitic high-nitrogen stainless steel, having a very fine material structure.

The present invention relates to rolling bearings for use submerged in fluids of very low temperature, such as in pumps designed to pump LPG (Liquified Petrol Gas) at temperatures below −47° C. and particularly LNG (Liquefied Natural Gas) at temperatures about and even below −160° C., such as liquefied hydrogen at −253° C.

Bearings for such purpose must be highly resistant to corrosion due to their contact with the fluid, which is pumped.

Highly corrosion resistant steels have traditionally been delivered in austenitic, ferritic or austenitic-ferritic structures, but such steels do not offer the high hardness required for rolling bearings to give adequate fatigue and wear resistance. Traditional bearing steels, such as AISI 52100 or AISI 440C are normally required to be of the hard martensitic phase to achieve the basic requirements with a hardness no lower than HRC 58 and a clean and fine structure. Traditional martensitic stainless bearing steels, for instance the AISI 440C steel, which is known to be “corrosion slow”, are only delivered with low corrosion protection and with reduced fatigue resistance.

U.S. Pat. No. 6,558,139 describes a self-lubricating rolling bearing for such an application, and which incorporates an inside and an outside race of stainless steel, such as for instance heat treated 440 stainless steel, a plurality of rolling bodies positioned between the inside and outside races, and a polymeric cage spacing apart the rolling bodies between the races, which is preferably made of polyether ether ketone (PEEK). The material in the rolling bodies can be ceramic rolling bodies or rolling bodies made from hardened stainless steel.

This earlier known rolling bearing thus has rings made from a material such as AISI 440C, and therefore has only low protection against corrosion and rather low fatigue resistance.

The purpose of the present invention is to propose a rolling bearing for use in a cryogenic environment, which has a high corrosion resistance and a high fatigue resistance and this has been achieved in that the bearing has been given the features defined in the accompanying claim 1.

The invention thus proposes a rolling bearing for use in a cryogenic pump where the bearing is submerged in fluid of a temperature below −100 degrees centigrade, and which incorporates an inside and an outside race of stainless steel, a plurality of rolling bodies positioned between the inside and outside races, and a polymeric cage spacing apart the rolling bodies between the races, wherein the inside and outside races consist of a super-tough martensitic high-nitrogen stainless steel, having a very fine material structure.

Advantageously the super-tough martensitic high-nitrogen stainless steel in the bearing races has a nitrogen content of 0.1-0.4 percentage by weight, and preferably the super-tough martensitic high-nitrogen stainless steel in the bearing races has been subjected to a cryogenic heat treatment for reducing the austenitic content of the material.

A typical composition of the super-tough martensitic steel is C 0.25-0.45%, Cr 13-17%, Mo 0.8-1.8%, N 0.15-0.45% and the remainder Fe and ordinary impurities (all percentages are by weight). The Rockwell C hardness HRC of this steel is >58.

Generally with this steel is used low temperature tempering at 180° C. for corrosion resistant applications. However the steel also shows secondary hardening after tempering at e.g. 480° C. where the as quenched retained austenite contents are also reduced by multiple high temperature tempering.

It is in this secondary hardened condition that the steel is used for cryogenic applications, however after hardening, the retained austenite content can also be reduced by deep freezing the bearing steel components at temperatures of −65° C. to −198° C. and preferably in the range of −75° C. to −150° C. depending op the application. With this combination of treatments deep freezing and secondary hardening hardness levels of 58 to 61 HRC can be achieved with retained austenite contents of <7 vol % and in this condition any remaining austenite is stabilised such that it will resist any temperature induced transformation, thus avoiding the formation of fresh untempered virgin martensite and associated irreversible volume changes, which would lead to loss of bearing component precision and an balanced loading condition.

The material has a fine microstructure (it is a high alloy steel with 13 to 17 wt % Cr), but by correct choice of hot working and soft shaping conditions together with subsequent hardening temperature and the above stabilisation, microstructures which are as fine as conventional bearing steel (AISI 52100, 1.5 wt % Cr) can be obtained, which are generally beneficial in terms of bearing life and load carrying capacity.

The material is through hardened at temperatures in the range of 1020° C. to 1060° C. and then secondary hardened by tempering in the temperature range of 460° C. to 520° C. The purpose of this treatment is to precipitate particles (within the matrix) of martensite in the form of nitride carbide or carbonitride zones. In this condition the material has:

(i) maximum strength

(ii) high microstructural (dimensional) stability in low temperature applications

(iii) good wear resistance under poorly lubricated conditions,

whilst still retaining corrosion and oxidation resistance (due to high chromium content) and maximizing the dissolved chromium after hardening—which is in part a consequence of the finely dispersed carbide, nitride particles formed in previous operations. The high levels and uniformly dissolved chromium confers high oxidation resistance and when local flash temperatures at rolling bearing contacts are encountered the oxidation resistance due to the chromium is beneficial. This condition can occur locally at asperity contacts in bearings lubricated with liquified gases.

The benefits are offered in situations where local flash temperatures are produced

The impact toughness of this new, super-tough martensitic steel has been substantially improved as compared e.g. to the AISI 52100, where the impact toughness of the new material is about 64 kJ/m² whereas the AISI 52100 has revealed a value of about 38 kJ/m².

The rolling bodies—balls or rollers—can preferably be manufactured from a silicon-nitride ceramic composite or alternatively from an alumina-zirconia ceramic composite.

It is advantageous to use a cage made of a high-performance polymeric material chosen from a group incorporating polyether ether ketone, known as PEEK; poly paraphenylene, e.g. TECAMAX from Ensinger Ltd, UK; polyimide, e.g. SINTIMID from Ensinger Ltd, UK and polyamide-imide, e.g. TORLON from Solvay Advanced Polymers, USA.

These polymers can be filled with fillers such as glass fibres, PTFE, graphite fibres, carbon black for improving the tribological and mechanical properties. Glass fibre fillers are often used in ranges of 0 to 30 volume %, commonly 10 to 30 volume %; whereas PTFE, graphite fibres and carbon black is used in ranges of 2 to 15 volume %.

1. A rolling bearing for use in a cryogenic pump where the bearing is submerged in fluid of a temperature below −100 degrees centigrade, and incorporating an inside and an outside race of stainless steel, a plurality of rolling bodies positioned between the inside and outside races, and a polymeric cage spacing apart the rolling bodies between the races, wherein, that the inside and outside race consist of a super-tough martensitic high-nitrogen stainless steel, having a very fine material structure.

2. A rolling bearing as claimed in claim 1, wherein, that the super-tough martensitic high-nitrogen stainless steel in the bearing races has a nitrogen content of 0.1-0.4 percentage by weight.

3. A rolling bearing as claimed in claim 1, wherein, that the super-tough martensitic high-nitrogen stainless steel in the bearing races has an austenitic content of below 7 volume %.

4. A rolling bearing as claimed in claim 1, wherein, that the polymeric cage is made of a material chosen from a group incorporating polyether either ketone; poly paraphenylene; polyimide and polyamide-imide.

5. A rolling bearing as claimed in claim 1, wherein, that the rolling bodes are manufactured from a silicon-nitride ceramic composite.

6. A rolling bearing as claimed in claim 1, wherein, that the rolling bodies are manufactured from an alumina-zirconia ceramic composite.
